(19) United States
(12) Patent Application Publication
(10) Pub. No.: US 2023/0037186 A1
(43) Pub. Date: Feb. 2, 2023

(54) DETERMINATION DEVICE

(71) Applicant: TOYO DENSO KABUSHIKI KAISHA, Tokyo (JP)

(72) Inventors: Koyo HIRATANI, Saitama (JP); Tadaaki OHARA, Saitama (JP)

(73) Assignee: TOYO DENSO KABUSHIKI KAISHA, TOKYO (JP)

(21) Appl. No.: 17/867,005

(22) Filed: Jul. 18, 2022

(30) Foreign Application Priority Data
Jul. 29, 2021 (JP) 2021-124520

(51) Int. Cl. H02P 29/024

(52) U.S. Cl. CPC H02P 29/0243; H02P 2207/05

(57) ABSTRACT

A determination device includes: an acquiring unit configured to acquire an electric current value detected in a state where electric current is flown in a plurality of directions in an electric motor so that torques produced in the electric motor are balanced; and a determining unit configured to perform disconnection determination of determining whether or not there is a disconnection based on the electric current value acquired by the acquiring unit.

### INCORPORATION BY REFERENCE

This application is based upon and claims the benefit of priority from Japanese patent application No. 2021-124520, filed on Jul. 29, 2021, the disclosure of which is incorporated herein in its entirety by reference.

### TECHNICAL FIELD

The present invention relates to a determination device and a determination method for determining the presence or absence of disconnection in an electric motor.

### BACKGROUND ART

A technique for determining the presence or absence of disconnection in an electric motor such as a brushless motor is known.

For example, Patent Document 1 describes a disconnection detecting device that includes a motor driver for energizing a winding of an electric motor, an electric current detecting unit for detecting an electric current flowing in the winding of the electric motor, and an energizing control unit. In the case of the technique described in Patent Document 1, the energizing control unit instructs the motor driver to energize. Then, after a predetermined time from when the energizing control unit instructs the motor driver to energize to when the electric current level of a normal winding of the electric motor reaches a predetermined value, the energizing control unit checks whether or not the electric current detecting unit detects an electric current of a predetermined level or more, and instructs the motor driver to brake energizing. For example, according to Patent Document 1, in a case where a counterclockwise rotation is detected when the motor is energized, the energizing control unit switches to an energizing pattern of rotating in the clockwise direction. Meanwhile, in a case where a clockwise rotation is detected when the motor is energized, the energizing control unit switches to an energizing pattern of rotating in the counterclockwise direction. Moreover, in a low-rotation region where rotation cannot be detected, the energizing control unit switches to a braking energizing pattern. For example, in Patent Document 1, through the processing as described above, rotation caused by energizing for disconnection detection is more quickly put to a stopped state.

### Patent Document 1: Japanese Patent Publication No. 3388525

In a case where the electric motor rotates at the time of performing determination of disconnection, there are problems such that a control unit for controlling the rotation at the time of disconnection determination is required and such that the rotation of the electric motor causes vibration and sound. In order to avoid these problems, it is desirable to prevent the electric motor from rotating at the time of disconnection determination as much as possible. However, in the case of the technique described in Patent Document 1, it is difficult to inhibit the rotation of the electric motor because torque is produced in one direction.

### SUMMARY OF THE INVENTION

Accordingly, an object of the present invention is to provide the abovementioned problem that it is difficult to perform disconnection determination while inhibiting the rotation of the electric motor.

A determination device as an aspect of the present invention includes: an acquiring unit configured to acquire an electric current value detected in a state where electric current is flown in a plurality of directions in an electric motor so that torques produced in the electric motor are balanced; and a determining unit configured to perform disconnection determination of determining whether or not there is a disconnection based on the electric current value acquired by the acquiring unit.

Further, a determination method as another aspect of the present invention is a determination method by a determination device including: acquiring an electric current value detected in a state where electric current is flown in a plurality of directions in an electric motor so that torques produced in the electric motor are balanced; and performing disconnection determination of determining whether or not there is a disconnection based on the acquired electric current value.

With the configurations as described above, the present invention can provide a determination device and a determination method that can perform disconnection determination while inhibiting the rotation of an electric motor.

### BRIEF DESCRIPTION OF DRAWINGS

FIG. 1 is a perspective view showing an example of a configuration of a determination system in a first example embodiment of the present invention;

FIG. 2 is a block diagram showing an example of a configuration of a determination device;

FIG. 3 is a view showing an example of a normal phase energizing pattern;

FIG. 4 is a view showing an example of a reverse phase energizing pattern;

FIG. 5 is a view showing an example of a positional relation, an energizing pattern, and a relation of torques in each section; and

FIG. 6 is a flowchart showing an example of an operation the determination device.

### EXAMPLE EMBODIMENT

### First Example Embodiment

In a first example embodiment of the present invention, a determination system 100 that performs disconnection determination in an electric motor 200 such as a three-phase brushless motor. As will be described later, in the determination system 100, an electric current value is measured in a state where an electric current is flown in a plurality of directions in the electric motor 200 so that torques produced in the electric motor are balanced. For example, in a case where a three-phase brushless motor is used as the electric motor 200, an electric current value is measured in a state where an electric current is flown from one phase on the upper stage to two phases on the lower stages or from two phases on the upper stage to one phase on the lower stage among the three phases. Then, the determination system 100 performs disconnection determination of determining the presence or absence of disconnection based on the measured current value.

In this example embodiment, “torques are balanced” refers to a state where, for example, in the case of Section 1 in a normal phase energizing pattern to be described later, torques are produced so as to be symmetrical about V phase toward U phase and W phase and so as to be the same magnitude. Torques of the same magnitude are produced by flowing electric current of the same magnitude through the respective phases.

Further, in the case of the determination system 100 described in this example embodiment, output is performed in a normal phase energizing pattern for the position of the rotor, and is also performed in a reverse phase energizing pattern in which a switching device 310 to be driven on and a switching device 310 to be driven off are counterchanged with those in the normal phase energizing pattern. Consequently, the determination system 100 can flow electric current through all the three phases in the two types of energizing patterns.

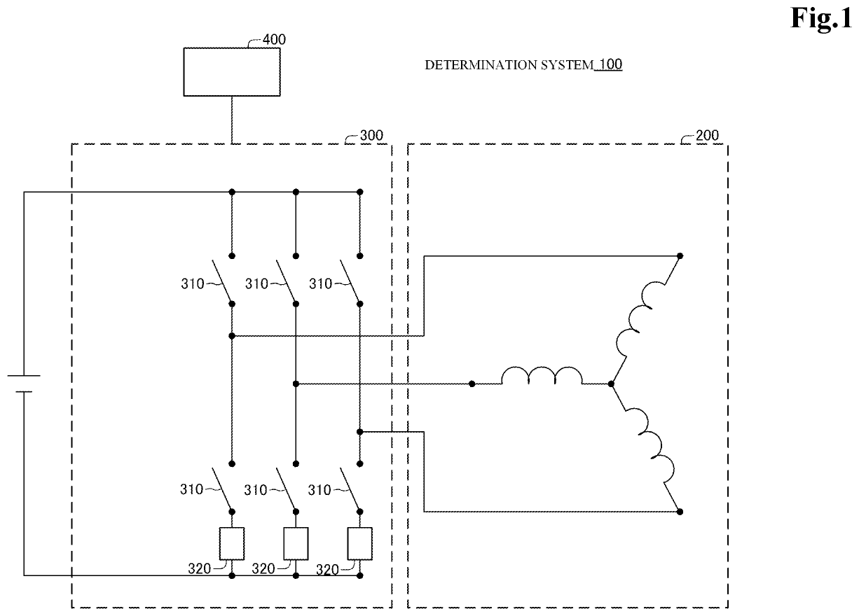

FIG. 1 shows an example of a configuration of the determination system 100. Referring to FIG. 1, the determination system 100 includes an electric motor 200 such as a three-phase brushless motor, a switch section 300, and a determination device 400. As shown in FIG. 1, the respective phases of the electric motor 200 are connected to the switch section 300. The determination device 400 is connected to each component included by the switch section 300 so as to be able to control the switching device 310 in accordance with an instruction by the determination device 400 and cause an electric current detection circuit 320 to transmit an electric current value detected thereby to the determination device 400.

The electric motor 200 is, for example, a widely used three-phase brushless motor having two poles and three slots. For example, the electric motor 200 has a stator, which is a winding coil, and a rotor, which is a permanent magnet, and the electric motor 200 has three phases of U phase, V phase, and W phase. Moreover, the electric motor 200 has, for example, three Hall sensors serving as position sensors, and is configured to be able to detect the position (angle) of the rotor. The electric motor 200 may have a configuration other than the configuration illustrated above, for example, a four-pole and six-slot configuration having not three Hall sensors but a different number of Hall sensors.

The switch section 300 has six switching devices 310 to be driven on or driven off in accordance with an instruction by the determination device 400 and the like. Specifically, the switch section 300 has three switching devices 310 on the upper stage that is the high side and three switching devices 310 on the lower stage that is the low side. In other words, the switch section 300 has the switching devices 310 corresponding to the respective phases of the electric motor 200 on the upper stage and lower stage than the electric motor 200. Moreover, the electric current detection circuit 320 that detects an electric current value is provided at a predetermined location on the lower stage in the switch section 300. For example, in the example of FIG. 1, the electric current detection circuit 320 is provided at a location corresponding to each of the lower stage switching devices 310. That is to say, the switch section 300 has three electric current detection circuits 320. The electric current detection circuit 320 may be provided on the upper stage. Moreover, the number of the electric current detection circuits 320 may be a number other than the number illustrated above.

The switching device 310 is, for example, an FET (Field Effect Transistor). For example, the switching device 310 is driven on or driven off in accordance with an instruction by the determination device 400 and the like. As described above, three switching devices 310 are provided on the upper stage, and three switching devices 310 are provided on the lower stage. The number of the switching devices 310 may be changed as necessary in accordance with the configuration of the electric motor 200.

The electric current detection circuit 320 detects an electric current value. For example, the electric current detection circuit 320 may be a widely used electric current detection circuit that measures an electric current value based on a voltage between shunt resistors. As described above, in this example embodiment, the electric current detection circuit 320 is provided at any location on the lower stage. The electric current detection circuit 320 may be provided at a location other than the location illustrated in this example embodiment, for example, on the upper stage.

The determination device 400 is an arithmetic logic unit of a microprocessor and the like that performs disconnection determination. The determination device 400 instructs the switching device 310 to be driven on or driven off, and acquires an electric current value from the electric current detection circuit 320. Moreover, the determination device 400 performs disconnection determination of determining whether or not there is a disconnection, and the like, based on the electric current value acquired from the electric current detection circuit 320.

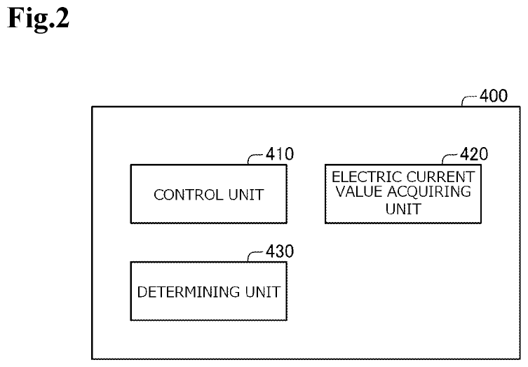

FIG. 2 shows an example of a configuration of the determination device 400. Referring to FIG. 2, the determination device 400 includes, for example, a control unit 410, an electric current value acquiring unit 420, and a determining unit 430. For example, the determination device 400 can realize the abovementioned processing units by executing a program stored in a storing unit. The determination device 400 may realize the abovementioned processing units by using a hardware such as a logic circuit.

The control unit 410 determines an energizing pattern of normal phase or reverse phase in accordance with the position of the rotor detected by the Hall sensors. Then, the control unit 410 instructs the switching devices 310 to be driven on or driven off so as to be in the determined normal phase or reverse phase energizing pattern. For example, the control unit 410 first identifies a section in accordance with the position of the rotor, and instructs the respective switching devices 310 to be driven on or driven off so as to be in the normal phase energizing pattern determined in accordance with the identified section. Moreover, in a case where a predetermined condition is satisfied, for example, in a case where the determining unit 430 determines that there is no disconnection and in a case where a predetermined maximum time has elapsed since the start of flowing an electric current in the normal phase energizing pattern, the control unit 410 instructs the respective switching devices 310 to be driven on or driven off so as to be in the reverse energizing pattern in the same section. The maximum time may be any value.

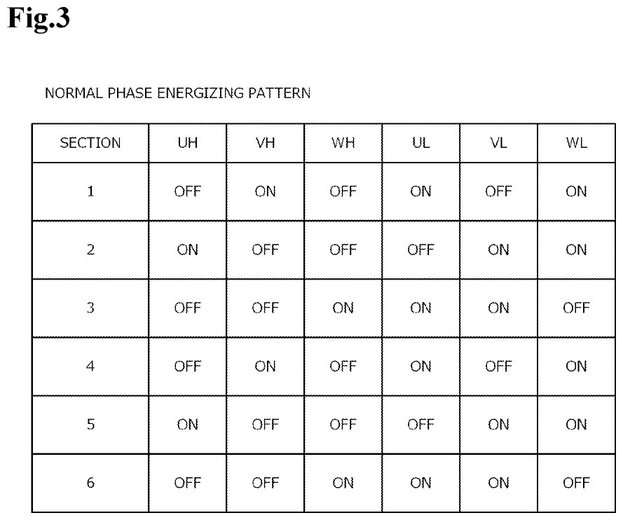

Specifically, for example, in a storage device included by the determination device 400 and the like, pattern information showing the relation between the position of the rotor and the normal phase and reverse phase energizing patterns as illustrated in FIGS. 3 to 5 is stored. The control unit 410 refers to control information stored in the storage device to determine an energizing pattern of normal phase or reverse phase in accordance with the position of the rotor detected by the Hall sensors.

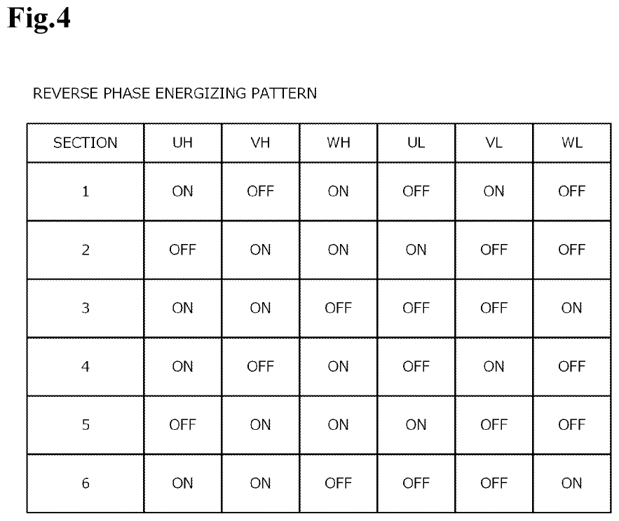

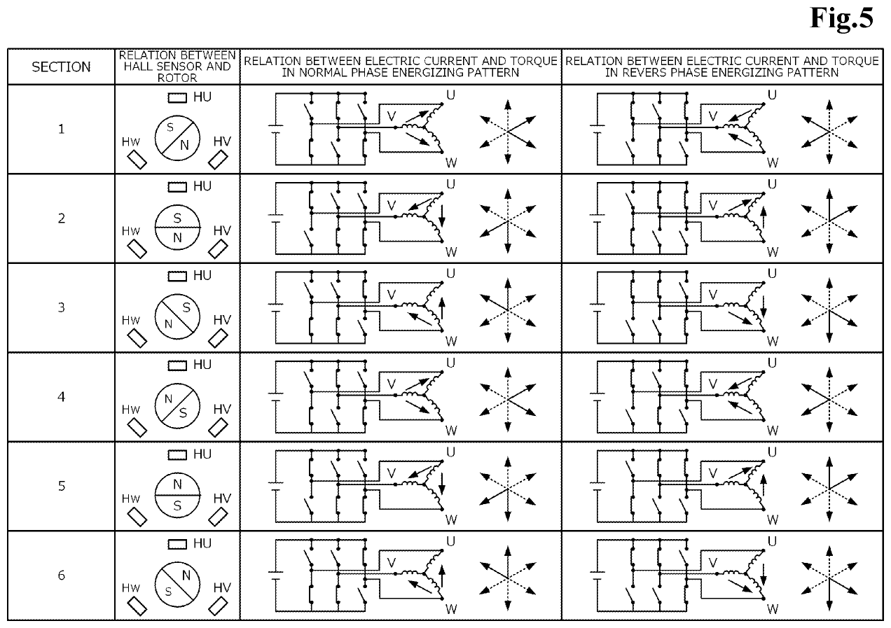

An example of the pattern information will be described with reference to FIGS. 3 to 5. In this example embodiment, energizing patterns shown in FIGS. 3 to 5 are defined as predetermined energizing patterns, but the energizing pattern is not limited to the described one. FIG. 5 shows an example of the position of the rotor and an example of the relation between the normal phase and reverse phase energizing patterns and torques. Moreover, FIG. 3 shows an example of the normal phase energizing pattern, and FIG. 4 shows an example of the reverse phase energizing pattern. As illustrated in FIGS. 3 to 5, the pattern information includes, for example, six pieces of information for the respective positions of the rotor. In the pattern information, for example, in a case where the section is the same (that is to say, the position of the rotor is the same), the switching devices 310 driven on/off are counterchanged between in the normal phase energizing pattern and in the reverse phase energizing pattern. For example, in a case where the position of the rotor corresponds to Section 1, in the normal phase energizing pattern, the switching device 310 corresponding to the upper-stage V phase is driven on and the switching devices 310 corresponding to the upper-stage W phase and the upper-stage U phase are driven off, whereas the switching devices 310 corresponding to the lower-stage U phase and the lower-stage W phase are driven on and the switching device 310 corresponding to the lower-stage V phase is driven off. As a result, in the electric motor 200, electric current flows from the upper-stage V phase to the lower-stage U phase and the lower-stage W phase, torques are produced in two directions, and the rotor stops at a position where the torques are balanced. On the other hand, in a case where the position of the rotor corresponds to Section 1, in the reverse phase energizing pattern, the switching devices 310 corresponding to the upper-stage U phase and the upper-stage W phase are driven on and the switching device 310 corresponding to the upper-stage V phase is driven off, whereas the switching device 310 corresponding to the lower-stage V phase is driven on and the switching devices 310 corresponding to the lower-stage W phase and the lower-stage U phase are driven off. As a result, in the electric motor 200, electric current flows from the upper-stage U phase and the upper-stage W phase to the lower-stage V phase, torques are produced in two directions, and the rotor stops at a position where the torques are balanced. As shown in FIGS. 3 to 5, in Sections 2 to 6, in a case where the position of the rotor corresponds to the same section, the switching device 310 to be driven on and the switching device 310 to be driven off are counterchanged between in the normal phase energizing pattern and in the reverse phase energizing pattern in the same manner as in Section 1.

FIGS. 3 to 5 show an example of the pattern information. The pattern information may be other than that illustrated in FIGS. 3 to 5. For example, the pattern information may show an energizing pattern other than that illustrated in FIGS. 3 to 5, which produces torques so as to be balanced in a plurality of directions by flowing electric current in a plurality of directions, according to the configuration of the electric motor 200. Moreover, the pattern information may be based on the number of Hall sensors, and the like.

Further, the control unit 410 may be configured to be able to perform a process of increasing the output so that a larger electric current flows when, for example, the determining unit 430 cannot determine that there is no disconnection. The increase of the output may be realized by any method. For example, the control unit 410 first instructs the respective switching devices 310 to be in the normal phase energizing pattern and thereafter, until a predetermined maximum time elapses, performs a process of increasing the output as necessary while waiting. Moreover, when the determining unit 430 determines that there is no disconnection, the control unit 410 instructs the respective switching devices 310 to be in the reverse phase energizing pattern and thereafter, until a predetermined maximum time elapses, performs a process of increasing the output as necessary while waiting. For example, as described above, the control unit 410 may be configured to, until the maximum time elapses in each of the normal phase energizing pattern and the reverse phase energizing pattern, perform a process of increasing the output as necessary, for example, when the determining unit 430 cannot determine that there is no disconnection. The control unit 410 may be configured to increase the output up to a predetermined number of times as necessary in each of the normal phase energizing pattern and the reverse phase energizing pattern.

The control unit 410 may be configured to confirm the position of the rotor as necessary, for example, when the determining unit 430 cannot determine that there is no disconnection.

The electric current value acquiring unit 420 acquires an electric current value detected by the electric current detection circuit 320 from the electric current detection circuit 320.

The determining unit 430 performs disconnection determination of determining whether or not there is disconnection based on the electric current value acquired by the electric current value acquiring unit 420. For example, the determining unit 430 performs disconnection determination of determining whether or not there is disconnection based on whether or not a predetermined condition is satisfied on each of the U phase, the V phase, and the W phase.

For example, the determining unit 430 confirms the energizing pattern and identifies the driven-on switching device 310 on the lower stage. Then, the determining unit 430 performs disconnection determination based on the electric current value acquired from the electric current detection circuit 320 for the driven-on switching device 310. For example, in a case where the electric current value acquired from the corresponding electric current detection circuit 320 is more than a predetermined energizing check threshold value, the determining unit 430 determines that there is no disconnection in the corresponding phase. Then, the determining unit 430 notifies determination of no disconnection to the control unit 410. On the other hand, in a case where the electric current value acquired from the corresponding electric current detection circuit 320 is equal to or less than the predetermined energizing check threshold value, the determining unit 430 determines that it cannot determine that there is no disconnection in the corresponding phase. Then, the determining unit 430 notifies to the control unit 410 and the like that it cannot determine that there is no disconnection. Moreover, the determining unit 430 determines that there is a disconnection in a case where it cannot determine that there is no disconnection when the maximum time has elapsed since the start of flowing electric current. The energizing check threshold value may be any value.

Further, the determining unit 430 may be configured to confirm whether or not to be able to determine that there is no disconnection based on an energizing check time, which is time when the acquired electric current value is more than a predetermined value (for example, the energizing check threshold value). For example, in a case where the energizing check time exceeds a check time threshold value, the determining unit 430 can determine that there is no disconnection in the corresponding phase. On the other hand, in a case where the energizing check time is equal to or less than the check time threshold value when a predetermined time has elapsed, the determining unit 430 can determine that it cannot determine that there is no disconnection in the corresponding phase.

Specifically, for example, in a case where the position of the rotor corresponds to Section 1 and the energizing pattern is the normal phase one, the switching devices 310 corresponding to the upper-stage V phase, the lower-stage U phase and the lower-stage W phase are driven on. Therefore, the determining unit 430 performs disconnection determination from the upper-stage V phase to the lower-stage U phase based on the electric current value acquired from the electric current detection circuit 320 corresponding to the lower-stage U phase, and also performs disconnection determination from the upper-stage V phase to the lower-stage W phase based on the electric current value acquired from the electric current detection circuit 320 corresponding to the lower-stage W phase. Meanwhile, in the case of Section 1 and the reverse phase energizing pattern, the switching devices 310 corresponding to the upper-stage U phase, the upper-stage W phase and the lower-stage V phase are driven on. Therefore, the determining unit 430 performs disconnection determination from the upper-stage U phase and the upper-stage W phase to the lower-stage V phase based on the electric current value acquired from the electric current detection circuit 320 corresponding to the lower-stage V phase.

For example, as described above, the determining unit 430 performs disconnection determination using the energizing check threshold value, the check time threshold value, and the like. However, the determining unit 430 may use only one of the methods illustrated above or a combination thereof

The determining unit 430 may be configured to determine that there is no disconnection (as a whole) in the case of determining that there is no disconnection either in the normal phase energizing pattern or in the reverse phase energizing pattern. Moreover, the determining unit 430 may be configured to determine that there is a disconnection in any of the three phases, for example, in a case where it cannot determine that there is no disconnection until the maximum time elapses in either the normal phase energizing pattern or the reverse phase energizing pattern.

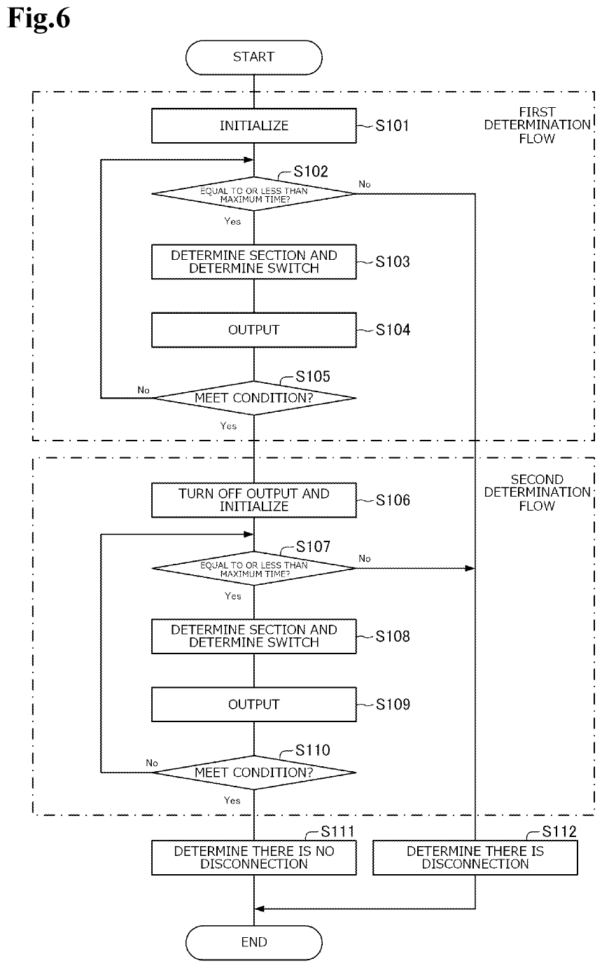

The above is an example of the configuration of the determination device 400. The determination device 400 may be configured to, for example, when the determining unit 430 determines that there is a disconnection in the normal phase energizing pattern, omit disconnection determination in the reverse phase energizing pattern. Subsequently, an example of an operation of the determination device 400 will be described with reference to FIG. 6. In FIG. 6, a case where disconnection determination in the normal phase is performed in a first determination flow and disconnection determination in the reverse phase is performed in a second determination flow is described.

FIG. 6 shows an example of an operation of the determination device 400. Referring to FIG. 6, the control unit 410 first performs an initialization process of initializing the switching device 310 and the like (step S101).

The control unit 410 confirms whether or not a maximum time has elapsed since the start of flowing an electric current in a determined energizing pattern (step S102). When it is equal to or less than the maximum time (step S102, Yes), the control unit 410 performs section determination in accordance with the position of the rotor detected by the Hall sensors, and determines the switching devices 310 to drive on/off (step S103). That is to say, the control unit 410 determines the normal phase energizing pattern in accordance with the position of the rotor. After that, an electric current flows in a state where the switching devices 310 are driven on or driven off in accordance with an instruction by the control unit 410 (step S104).

The determining unit 430 confirms whether or not an electric current value acquired by the electric current value acquiring unit 420 meets a predetermined condition (step S105). In a case where the electric current value does not meet the condition (step S105, No), the control unit 410 can increase the output so that a larger electric current flows. After that, the operation returns to the processing at step S102.

On the other hand, in a case where the electric current value meets the condition (step S105, Yes), the control unit 410 turns off the output and performs the initialization process of initializing (step S106).

The control unit 410 confirms whether or not the maximum time has elapsed since the start of flowing an electric current in a newly determined energizing pattern (step S107). In a case where it is equal to or less than the maximum time (step S107, Yes), the control unit 410 performs section determination in accordance with the position of the rotor detected by the Hall sensors, and determines the switching devices 310 to drive on/off (step S108). That is to say, the control unit 410 determines the normal phase energizing pattern in accordance with the position of the rotor. Moreover, an electric current flows in a state where the switching devices 310 are driven on or driven off in accordance with an instruction by the control unit 410 (step S109). The processing at step S108 may be omitted.

The determining unit 430 confirms whether or not an electric current value acquired by the electric current value acquiring unit 420 meets a predetermined condition (step S110). In a case where the electric current value does not meet the condition (step S110, No), the control unit 410 can increase the output so that a larger electric current flows. After that, the operation returns to the processing at step S107. On the other hand, in a case where the electric current value meets the condition (step S110, Yes), the determining unit 430 determines that there is no disconnection in all the three phases (step S111).

Further, in a case where the maximum time has elapsed since the start of flowing an electric current (step S102, No, or step S107, No), the determining unit 430 determines that there is a disconnection (step S112). The determining unit 430 may determine that there is a disconnection in the corresponding phase, or may determine that there is a disconnection in any of the three phases.

The above is an example of the operation of the determination device 400.

In the example shown in FIG. 6, for example, steps S101 to S105 belong to a first determination flow to perform disconnection determination in the normal phase energizing pattern, and steps S106 to S110 belong to a second determination flow to perform disconnection determination in the reverse phase energizing pattern. In conventional techniques, at the time of performing disconnection determination, a regenerative control flow for stopping the rotation of the rotor has been required after the first determination flow or the second determination flow. On the other hand, in the present invention, at the time of performing disconnection determination, the regenerative control flow is not required because the rotation of the rotor does not occur, and it is possible to perform the second determination flow immediately after the first determination flow. That is to say, according to the present invention, for example, when it is determined in the first determination flow that there is no disconnection, it is possible to directly shift from the first determination flow to the second determination flow without the regeneration control flow or the like therebetween.

Although disconnection determination in the normal phase is performed in the first determination flow and disconnection determination in the reverse phase is performed in the second determination flow in the operation flow of FIG. 6, disconnection determination in the reverse phase may be performed in the first determination flow and disconnection determination in the normal phase may be performed in the second determination flow according to the present invention.

As described above, the determination device 400 includes the control unit 410 and the determining unit 430. With such a configuration, the determining unit 430 can perform disconnection determination based on an acquired electric current value in a state where the control unit 410 drives on and off the switching devices 310 so that the torques are balanced. As a result, the determining unit 430 can perform the disconnection determination without rotating the electric motor 200.

Further, the control unit 410 is configured to instruct the respective switching devices 310 to flow an electric current in the normal phase energizing pattern and the reverse phase energizing pattern in which the driven-on switching device 310 and the driven-off switching device 310 are counterchanged with each other. With such a configuration, it is possible to efficiently perform disconnection determination while inhibiting rotation of the electric motor 200.

The configuration of the determination device 400 may be other than the configuration illustrated in this example embodiment. For example, the determination device 400 may be configured to flow electric current through all the three phases by a method such as using a plurality of types of normal phase energizing patterns or using a plurality of types of reverse phase energizing patterns. That is to say, the determination device 400 does not always need to be configured to use the normal phase and reverse phase energizing patterns.

Further, the electric current detection circuit 320 may be provided at a location other than the location illustrated in this example embodiment as long as provided on the upper stage or lower stage than the electric motor 200. That is to say, the electric current detection circuit 320 may be provided outside the switch section 300.

### Supplementary Notes

The whole or part of the example embodiments disclosed above can be described as the following supplementary notes. Below, the overview of the configuration of the determination device according to the present invention will be described. However, the present invention is not limited to the following configurations.

### Supplementary Note 1

A determination device comprising:

an acquiring unit configured to acquire an electric current value detected in a state where electric current is flown in a plurality of directions in an electric motor so that torques produced in the electric motor are balanced; and

a determining unit configured to perform disconnection determination of determining whether or not there is a disconnection based on the electric current value acquired by the acquiring unit.

### Supplementary Note 2

The determination device according to Supplementary Note 1, comprising

a control unit configured to drive a switching device corresponding to each phase of the electric motor,

wherein the acquiring unit is configured to acquire the electric current value in a state where the control unit drives the switching device in accordance with a position of a motor included by the electric motor.

### Supplementary Note 3

The determination device according to Supplementary Note 2, wherein:

the electric motor is a three-phase electric motor; and

the control unit is configured to drive the switching device so that electric current flows from one phase on an upper stage to two phases on a lower stage of three phases or from two phases on the upper stage to one phase on the lower phase of the three phases.

### Supplementary Note 4

The determination device according to Supplementary Note 2, wherein

the control unit is configured to drive the switching device so that electric current flows in a predetermined normal phase energizing pattern, and also drive the switching device so that electric current flows in a reverse phase energizing pattern in which the switching device to drive is counterchanged with that in the normal phase energizing pattern.

### Supplementary Note 5

The determination device according to Supplementary Note 4, wherein:

the determining unit has a first determination flow to perform the disconnection determination in one of the normal phase energizing pattern and the reverse phase energizing pattern and a second determination flow to perform the disconnection determination in the other one of the normal phase energizing pattern and the reverse phase energizing pattern; and

in a case where it is determined that there is no disconnection in the first determination flow, an operation directly shifts from the first determination flow to the second determination flow

### Supplementary Note 6

The determination device according to any of Supplementary Notes 1 to 5, wherein:

an electric current detection circuit configured to detect the electric current value is provided on a lower stage side than the electric motor; and

the acquiring unit is configured to acquire the electric current value from the electric current detection circuit.

### Supplementary Note 7

A determination method by a determination device, comprising:

acquiring an electric current value detected in a state where electric current is flown in a plurality of directions in an electric motor so that torques produced in the electric motor are balanced; and

performing disconnection determination of determining whether or not there is a disconnection based on the acquired electric current value.

Although the present invention has been described above with reference to the example embodiments, the present invention is not limited to the above example embodiments. The configurations and details of the present invention can be changed in various manners that can be understood by one skilled in the art within the scope of the present invention.

### DESCRIPTION OF NUMERALS

100 determination system
200 electric motor
300 switch section
310 switching device
320 electric current detection circuit
400 determination device
410 control unit
420 electric current value acquiring unit
430 determining unit

1. A determination device comprising:
an acquiring unit configured to acquire an electric current value detected in a state where electric current is flown in a plurality of directions in an electric motor so that torques produced in the electric motor are balanced; and
a determining unit configured to perform disconnection determination of determining whether or not there is a disconnection based on the electric current value acquired by the acquiring unit.

2. The determination device according to claim 1, comprising
a control unit configured to drive a switching device corresponding to each phase of the electric motor,
wherein the acquiring unit is configured to acquire the electric current value in a state where the control unit drives the switching device in accordance with a position of a motor included by the electric motor.

3. The determination device according to claim 2, wherein:
the electric motor is a three-phase electric motor; and
the control unit is configured to drive the switching device so that electric current flows from one phase on an upper stage to two phases on a lower stage of three phases or from two phases on the upper stage to one phase on the lower phase of the three phases.

4. The determination device according to claim 2, wherein
the control unit is configured to drive the switching device so that electric current flows in a predetermined normal phase energizing pattern, and also drive the switching device so that electric current flows in a reverse phase energizing pattern in which the switching device to drive is counterchanged with that in the normal phase energizing pattern.

5. The determination device according to claim 4, wherein:
the determining unit has a first determination flow to perform the disconnection determination in one of the normal phase energizing pattern and the reverse phase energizing pattern and a second determination flow to perform the disconnection determination in the other one of the normal phase energizing pattern and the reverse phase energizing pattern; and
in a case where it is determined that there is no disconnection in the first determination flow, an operation directly shifts from the first determination flow to the second determination flow

6. The determination device according to claim 1, wherein:
an electric current detection circuit configured to detect the electric current value is provided on a lower stage side than the electric motor; and
the acquiring unit is configured to acquire the electric current value from the electric current detection circuit.

7. A determination method by a determination device, comprising:
acquiring an electric current value detected in a state where electric current is flown in a plurality of directions in an electric motor so that torques produced in the electric motor are balanced; and
performing disconnection determination of determining whether or not there is a disconnection based on the acquired electric current value.
